(19) United States
(12) Patent Application Publication
(10) Pub. No.: US 2024/0070730 A1
(43) Pub. Date: Feb. 29, 2024

(54) Using a Trained Neural Network to Standardize User Product Ratings on Online Systems

(71) Applicant: International Business Machines Corporation, Armonk, NY (US)

(72) Inventors: Shikhar Kwatra, San Jose, CA (US); Vijay Ekambaram, Chennai (IN); Anvita Vyas, Madhya Pradesh (IN); Jeremy R. Fox, Georgetown, TX (US)

(21) Appl. No.: 17/823,130

(22) Filed: Aug. 30, 2022

(51) Int. Cl. G06Q 30/02

(52) U.S. Cl. CPC G06Q 30/0282; G06Q 30/0201

(57) ABSTRACT

Using a trained neural network to transform user ratings into standardized user ratings is provided. Respective attribute-based leniency and strictness rating scores are generated for a plurality of attributes associated with a product category using the trained neural network based on historical user ratings of products in the product category. A set of attributes associated with a product included in the product category is identified. An overall leniency and strictness rating score is determined for the product using the trained neural network based on a set of attribute-based leniency and strictness rating scores for the set of attributes associated with the product included in the product category. A user rating of the product is received. The user rating of the product is adjusted based on the overall leniency and strictness rating score for the product included in the product category to form a standardized user rating for the product.

### BACKGROUND

### 1. Field

The disclosure relates generally to neural networks and more specifically to using a trained neural network to standardize user product ratings in online systems.

### 2. Description of the Related Art

An artificial neural network reflects the behavior of a human brain, allowing computers to recognize patterns and solve problems. An artificial neural network is comprised of multiple node layers, containing an input layer, a set of hidden layers, and an output layer. Each node, or artificial neuron, of a layer connects to another node of another layer and has an associated weight and threshold. If the output of any individual node is above the specified threshold value, then that node is activated and sends data to the next layer of the neural network. The artificial neural network relies on training data to learn and improve its accuracy over time.

### SUMMARY

According to one illustrative embodiment, a computer-implemented method for using a trained neural network to transform user ratings into standardized user ratings is provided. A computer, using the trained neural network, generates respective attribute-based leniency and strictness rating scores for a plurality of attributes associated with a particular product category of a plurality of product categories based on historical user ratings of products in the particular product category. The computer identifies a set of attributes associated with a product included in the particular product category. The computer, using the trained neural network, determines an overall leniency and strictness rating score for the product based on a set of attribute-based leniency and strictness rating scores for the set of attributes associated with the product included in the particular product category. The computer receives a user rating of the product from a client device corresponding to a user via a network. The computer adjusts the user rating of the product based on the overall leniency and strictness rating score for the product included in the particular product category to form a standardized user rating for the product. According to other illustrative embodiments, a computer system and computer program product for using a trained neural network to transform user ratings into standardized user ratings are provided.

### BRIEF DESCRIPTION OF THE DRAWINGS

FIG. 1 is a pictorial representation of a computing environment in which illustrative embodiments may be implemented;

FIG. 2 is a diagram illustrating an example of a user product rating standardizing system in accordance with an illustrative embodiment;

FIG. 3 is a diagram illustrating an example of a product attribute-based user rating standardization process in accordance with an illustrative embodiment;

FIG. 4 is a diagram illustrating an example of a user rating adjustment process in accordance with an illustrative embodiment;

FIG. 5 is a flowchart illustrating a process for using a trained neural network to transform user ratings of products into standardized user ratings in accordance with an illustrative embodiment; and

FIGS. 6A-6B are a flowchart illustrating a process for adjusting user ratings of products in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

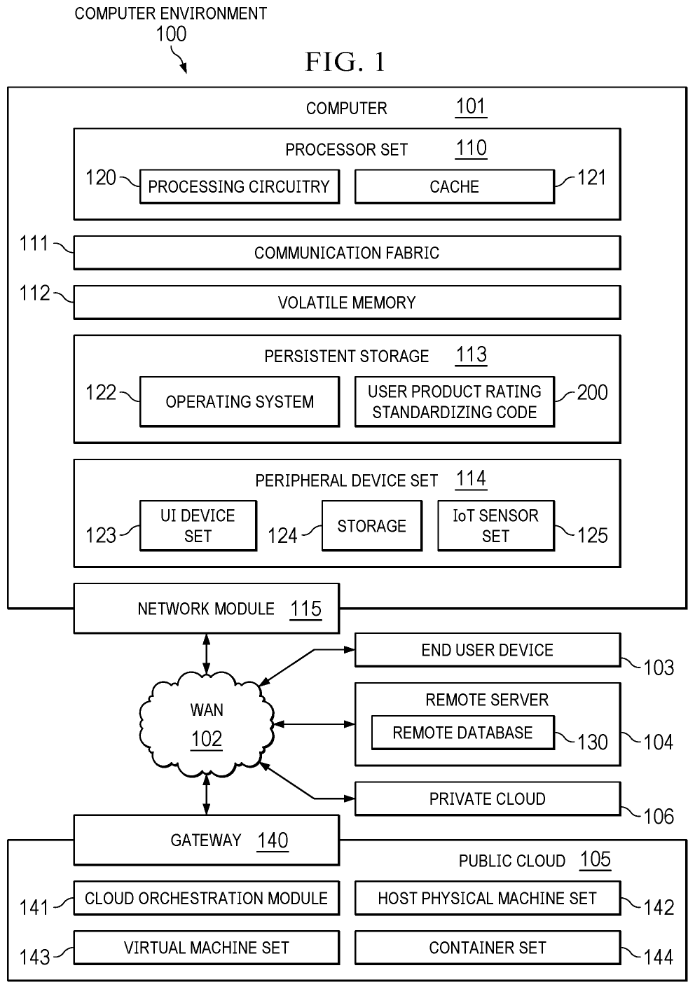

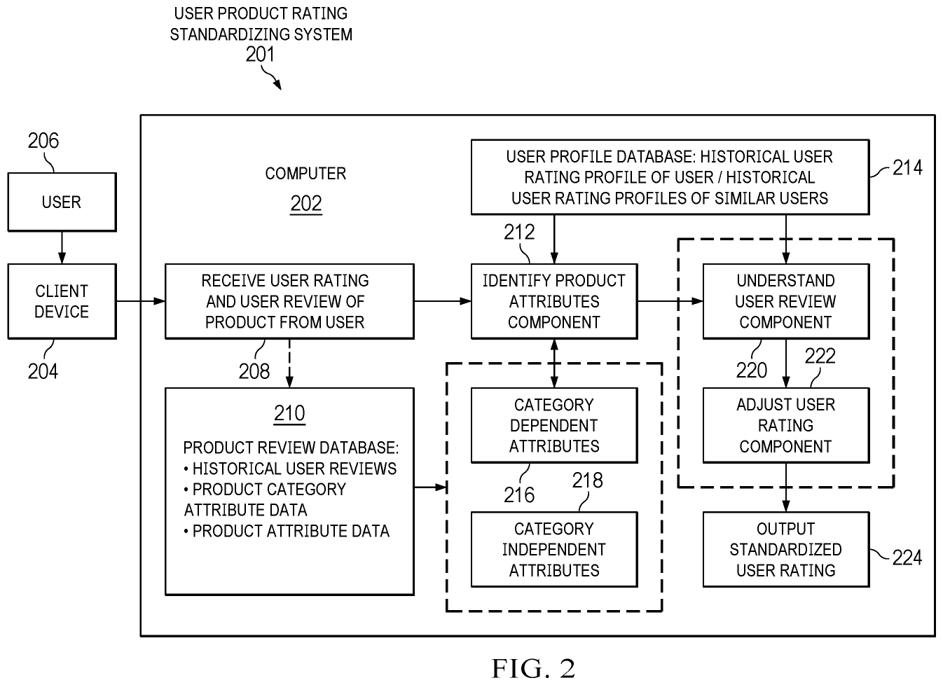

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as user product rating standardizing code 200. User product rating standardizing code 200 standardizes user ratings corresponding to a product by eliminating variance in leniency and strictness of the user product ratings across users. This is a novel process. For example, current user rating systems do not calculate leniency and strictness user product rating scores based on attributes (e.g., features, characteristics, traits, aspects, properties, and the like) of the products. For example, a user may have different leniency and strictness user product rating scores for different categories of products. For example, the user can tolerate a decreased color quality for an electronics product but not for a clothing product. Consequently, based on the category of product, user product rating standardizing code 200 infers a set of product attributes that are important to the user and determine a strictness and leniency user product rating score corresponding to the user based on the inferred set of user-important product attributes. User product rating standardizing code 200 can also adjust relative weightings of different product attributes based on the user's historic personalized interactions with the product stored in a user profile corresponding to the user. Based on the inferred set of user-important product attributes, user product rating standardizing code 200 standardizes the user rating of the product by determining the attribute-based leniency and strictness user product rating score personalized to the user in the context of the particular category of the product and adjusting the user rating of the product based on the user-personalized, attribute-based leniency and strictness rating score to form the standardized user rating for the product. It should be noted that as used herein the term product can also include a service.

In addition to product rating standardizing code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and product rating standardizing code block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in product rating standardizing code block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The product rating standardizing code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

User ratings in online product review systems can serve as a good indicator as to the quality of a particular product or service. As a result, current online product review systems should establish a standardized and reliable user rating process. For example, range of product ratings between different users varies greatly in current user rating processes. For example, one user, even if the user considers the product to be great, will give the product a rating of 4 out of 5, while another user, even if this other user considers the product to be just okay, will give the product a rating of 5 out of 5. Thus, some users are stricter while rating a product while others are more lenient in rating the same product. Consequently, plain averaging of user ratings for a product does not provide a reliable overall user rating for the product. To address this issue of variances in user ratings of products, illustrative embodiments provide a novel process to transform user ratings of products to a standardized user rating by removing or decreasing the variance in leniency and strictness of ratings given by different users for products using a trained neural network.

Illustrative embodiments determine attribute-based leniency and strictness rating scores for a plurality of users based on historical user ratings and reviews for a plurality of products in user profiles. By comparing user ratings of products with standardized user ratings of these products, illustrative embodiments train a neural network (e.g., a deep-learning transformation, machine learning model, or the like) that can derive a leniency and strictness rating score of a user for a product based on attributes of the product, which illustrative embodiments have determined are important to that user for that particular product. Attributes can include various features or characteristics of the product, which illustrative embodiments can extract using, for example, supervised, semi-supervised, or unsupervised machine learning techniques.

Illustrative embodiments transform the user rating of the product provided by the user to a standardized user rating based on the leniency and strictness rating score for the user, which is generated by the trained neural network. In addition, when user reviews are also available with the user ratings, illustrative embodiment can learn conflicts between user ratings and user sentiments expressed in the reviews and use the learned conflicts between user ratings and user reviews to further improve the standardization of user ratings. Thus, illustrative embodiments generate an attribute-based leniency and strictness rating score of a user for a product based on historical user ratings and reviews of the product and utilize the attribute-based leniency and strictness rating score to standardize the user rating of the product to eliminate variance in leniency and strictness of user ratings of products across users.

Also, for very different user reviews of a product, the user ratings can be the same. For example, one user can indicate in the user review that the product was not worth the price, while another user indicates that the product is okay for the price, but the user rating given by both users is the same (e.g., a rating of 3). Further, users can give the same user rating (e.g., either positive or negative) for a product based on different attributes of that product. For example, one user gives a user rating of 2 for a product based on quality of the product, while another user gives a user rating of 2 for that same product based on price of the product. These dichotomies unfairly influence user ratings.

Product ratings given by a user depend on how lenient or strict the user is regarding these product ratings and depend on multiple product attributes that impact the product ratings by the user, such as, for example, cost, quality, color, configuration, return policy, geographic location, ease of use, user's expectation, and the like, based on category of the product, such as, for example, electronics, software, clothing, food, sporting equipment, cosmetics, appliances, furniture, vehicles, and the like.

The average of user ratings is derived by summing all the user ratings and then dividing the sum of the user ratings by the total number of user ratings. For example, an equation to calculate the average user rating may be:

$$Ravg = \frac{{\sum }_{k = 0}^{N} Rk}{N} .$$

However, this averaging of user ratings does not take into account any bias a user may have regarding attributes of different product categories. For example, these average user ratings do not take into account text of user reviews, which corresponds to the user ratings, while calculating the average user rating for a product.

Illustrative embodiments do not determine leniency and strictness rating scores based on the same product attributes for each respective category of product. For example, illustrative embodiments can determine that a user may have a different leniency and strictness rating score for each different category of product. For example, a user may tolerate decreased quality of an attribute, such as color, for an electronics product, but not for a clothing product. As a result, illustrative embodiments, based on each product category, infer a set of product attributes that are important to a user using, for example, clustering, topic modeling, keyword extraction, historical user ratings and reviews of products stored in a profile of the user, and the like and calculate a leniency and strictness rating score for the user based on the set of user-important product attributes using the trained neural network. Further, illustrative embodiments can calculate and adjust relative weights of different attributes of the product based on each user's historical personalized interactions with that product.

Illustrative embodiments determine attributes of products by, for example, clustering attributes identified using topic modeling, keyword extraction, and the like. For example, during data curation, illustrative embodiments can determine category and subcategory of each product from information contained in a product listing page or metadata corresponding to each respective product. In addition, illustrative embodiments can also data mine user reviews of a plurality of products to curate an extended list of user reviews. Further, illustrative embodiments can remove or filter out user reviews that do not provide any useful information or contain any relevant product attributes. For example, illustrative embodiments can remove user product reviews that only include one word, such as good, bad, ugly, nice, or the like.

Furthermore, illustrative embodiments can infer product attributes. For example, some product attributes are common across all product categories, while other product attributes are specific to only one particular product category. Category dependent attributes are product features or characteristics that are specific to a particular category of product. For example, the product attribute of taste is specific to the product category of food, the product attribute of fabric type is specific to the product category of clothing, the product attribute of processor speed is specific to the product category of electronics, and the like. Category independent attributes are product features or characteristics that are general to all categories of products. For example, product attributes such as cost, value, description accuracy, and the like are common to all product categories.

After illustrative embodiments filter out user reviews that do not contain useful information (e.g., relevant product attributes), illustrative embodiments utilize a clustering algorithm to cluster remaining user reviews per corresponding product category to determine similar user reviews within a product category cluster of user reviews to identify similar users. Moreover, illustrative embodiments can also utilize topic modeling techniques to identify and extract product attribute “topics” referenced or discussed in user reviews for a particular product category or sub-category. Furthermore, illustrative embodiments can also utilize keyword extraction techniques to identify and extract product attribute “keywords” referenced in user reviews for a particular product category or sub-category.

Illustrative embodiments can also utilize a trained multi-class classifier to identify product attributes. For example, illustrative embodiments train the multi-class classifier using a plurality of defined product attributes, which includes both category dependent attributes and category independent attributes. Category dependent attributes may be, for example, fabric type, style, fit, feel, and the like for a clothing product category. Category independent attributes may be, for example, price, quality, life expectancy, and the like for all product categories. In addition, attributes may have sub-attributes. For example, the product attribute of price may have sub-attributes such as overpriced, cheap, good buy, and the like. Output of the trained multi-class classifier is whether text of the user review includes product attributes or not and whether the detected product attributes are category dependent or independent attributes. The trained multi-class classifier labels those product attributes that were evaluated using clustering of product attributes identified by topic modeling, keyword extraction, and the like.

An example of a user review of a product may be, “I wish I could rate this product as a zero (0). The phone cover appears to be made of very thin plastic material like polythene and not rubber. This is low quality material. Paying 20 dollars for this product is too expensive. It provides no protection for your phone against falls.” Illustrative embodiments first analyze the user review using at least one of topic modeling or keyword extract to identify attributes of the product contained in the text of the user review. Then, illustrative embodiments input the text of the user review into the trained multi-class classifier to detect whether a set of attributes corresponding to the product exist or not in the text and, if attributes do exist in the text, determine whether the attributes include at least one of category dependent attributes or category independent attributes. In this example, the set of attributes corresponding to the product may be low quality, expensive, no protection, and the like.

Illustrative embodiments can determine an adjustment for a user rating when the user rating does not include a user review of the product. For example, when a user review is not present with the user rating of the product, illustrative embodiments utilize previous reviews of the product by the user to learn and understand the user's review profile of that particular product. In the event the user does not have any previous reviews of the product, illustrative embodiments utilize historical reviews of that product made by other similar users. Illustrative embodiments utilize historical user reviews to learn and understand which attributes of the product are important to that particular user. Also, illustrative embodiments can infer a leniency and strictness user rating profile for each respective user per each product category and attribute.

When a user review of the product is present with the user rating, illustrative embodiments can analyze the text of the user review to learn and understand which attributes of the product are important to that particular user. Furthermore, illustrative embodiments can utilize a sentiment or emotion classifier to analyze the text of the user review to learn and understand the user's degree of satisfaction or dissatisfaction with the product. For example, if illustrative embodiments determine that a user review of a product is a highly positive review indicating very high user satisfaction with the product and if this very high user satisfaction is not reflected in the user's rating of the product (e.g., a user rating of 3 or 4 out of 5 rather than a 5), then illustrative embodiments determine that this particular user is strict with regard to user ratings of products. Similarly, if illustrative embodiments determine that the user review of the product is a highly negative review indicating very low user satisfaction with the product and if this very low user satisfaction is not reflected in the user's rating of the product (e.g., a user rating of 2 or 3 out of 5 rather than a 1), then illustrative embodiments determine that this particular user is lenient with regard to user ratings of products. Thus, the sentiment or emotion classifier can assist illustrative embodiments in determining how much importance or weight to apply to different attributes of the product for that particular user. Moreover, illustrative embodiments can utilize co-referenced products in a user review to determine product attribute importance.

Illustrative embodiments train the neural network to derive the leniency and strictness rating score of a particular user for a product based on attributes of that product that illustrative embodiments determine are important to that particular user. The training of the neural network increases the accuracy of the neural network in deriving leniency and strictness scores of users based on product attributes. Illustrative embodiments utilize the trained neural network to determine the adjustment to the user rating of the product based on the derived leniency and strictness rating score to generate the standardized user rating to eliminate variance across users. Current online user rating systems suffer from an inability to standardize user product ratings based on product attributes.

Thus, illustrative embodiments provide one or more technical solutions that overcome a technical problem with an inability of current online user rating systems to standardize user product ratings. As a result, these one or more technical solutions provide a technical effect and practical application in the field of artificial neural networks to transform user product ratings to standardize user product ratings eliminating leniency and strictness in user ratings of products across all users.

With reference now to FIG. 2, a diagram illustrating an example of a user product rating standardizing system is depicted in accordance with an illustrative embodiment. User product rating standardizing system 201 may be implemented in a computing environment, such as computing environment 100 in FIG. 1. User product rating standardizing system 201 is a system of hardware and software components for transforming user ratings of products to standardized user ratings of the products using a trained neural network to eliminate variance in leniency and strictness of the user ratings of the products across all users.

In this example, user product rating standardizing system 201 includes computer 202 and client device 204. Computer 202 and client device 204 may be, for example, computer 101 and end user device (EUD) 103 in FIG. 1, which communicate via a network, such as WAN 102 in FIG. 1. However, it should be noted that user product rating standardizing system 201 is meant as an example only and not as a limitation on illustrative embodiments. In other words, user product rating standardizing system 201 can include any number of computers, client devices, and other devices and components not shown.

User 206 utilizes client device 204 to generate and send a user rating and review of a product to computer 202. At 208, computer 202 receives the user rating and the user review of the product from user 206 via client device 204. Computer 202 stores the user review of the product in product review database 210. Computer 202 utilizes product review database 210 to store historical user reviews of a plurality of different products, along with general product category attribute data corresponding to the plurality of different products, specific product attribute data corresponding to the plurality of different products, information regarding a plurality of different product categories, information regarding the plurality of different products, and the like.

Computer 202 utilizes identify product attributes component 212 to detect and extract any product attributes that user 206 may have included in the user review of the product. Identify product attributes component 212 accesses information in user profile database 214 to assist in detecting the product attributes present in the user review of the product. User profile database 214 stores historical user rating and review profiles of a plurality of different users. A historical user rating and review profile of a user contains, for example, user identifier, any previous ratings and reviews of products made by the user, identification of the products rated and reviewed, identification of the category and subcategory of each product rated and reviewed, any product attributes referenced in product reviews made by the user, and any previous leniency and strictness scores corresponding to the user for products, attributes of the products, and categories of the products.

Further, identify product attributes component 212 searches user profile database 214 for a historical user rating and review profile that corresponds to user 206. If a historical user rating and review profile of user 206 exists in user profile database 214, then identify product attributes component 212 utilizes that profile to assist in detecting the attributes of the product referenced in the current user review of the product. If a historical user rating and review profile of user 206 does not currently exist in user profile database 214, then identify product attributes component 212 utilizes a set of historical user rating and review profiles of a set of users similar to user 206 to assist in detecting the attributes of the product referenced in the current user review of the product. Identify product attributes component 212 may utilize, for example, clustering of information contained in user profile database 214 to identify the set of users similar to user 206.

In addition, identify product attributes component 212 may utilize, for example, topic modeling and keyword extraction to detect and extract attributes referenced in the user review of the product. Furthermore, identify product attributes component 212 determines whether detected attributes of the product are at least one of category dependent attributes 216 or category independent attributes 218 using the information contained in product review database 210. Afterward, identify product attributes component 212 sends any identified category dependent attributes 216 and category independent attributes 218 of the product to understand user review component 220.

Computer 202 utilizes understand user review component 220 to recognize and resolve any conflict between the user rating and the user review of the product, recognize any leniency or strictness in the user rating of the product, and generate an attribute-based leniency and strictness score of user 206 for the product based on any identified category dependent attributes 216 and category independent attributes 218 of the product and the information contained in user profile database 214. Understand user review component 220 utilizes a trained artificial neural network to generate the attribute-based leniency and strictness score. Then, computer 202 utilizes adjust user rating component 222 to transform the user rating of the product to a standardized user rating based on the attribute-based leniency and strictness score. At 224, computer 202 outputs the standardized user rating to an online product review website via the network.

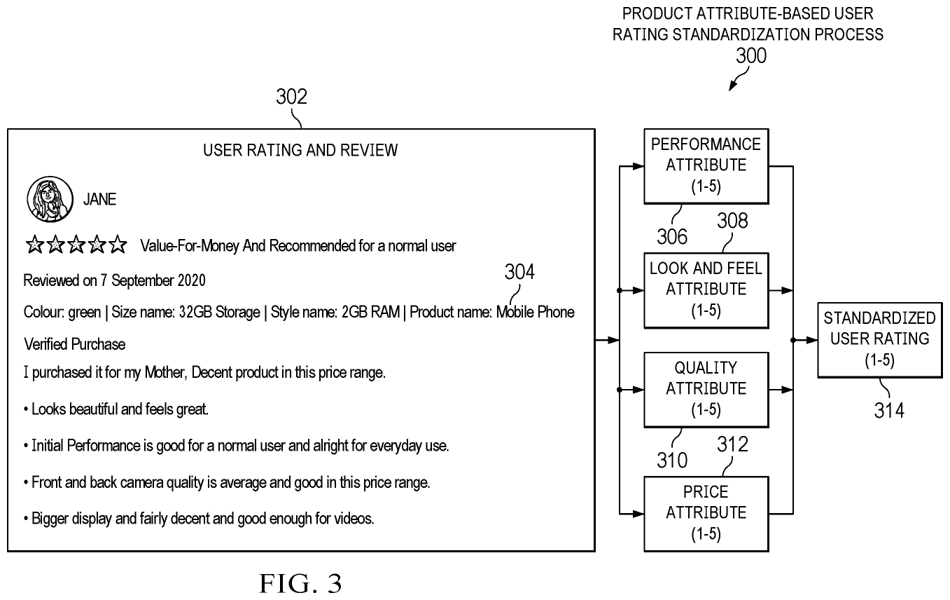

With reference now to FIG. 3, a diagram illustrating an example of a product attribute-based user rating standardization process is depicted in accordance with an illustrative embodiment. Product attribute-based user rating standardization process 300 may be implemented in a computer, such as, for example, computer 101 in FIG. 1 or computer 202 in FIG. 2.

In this example, product attribute-based user rating standardization process 300 includes user rating and review 302 of product 304, which in this example is a mobile phone. However, it should be noted that user rating and review 302 is intended as an example only. In other words, user rating and review 302 may be for any type of product or service and include any type of product review information.

Also in this example, the user “Jane” gives a 4 out of a possible 5 stars user rating for product 304. Based on the information contained in user rating and review 302 of product 304, product attribute-based user rating standardization process 300 detects performance attribute 306 (e.g., “performance is good”), look and feel attribute 308 (e.g., “looks beautiful and feels great”), quality attribute 310 (e.g., “camera quality is average”), and price attribute 312 (e.g., “good in this price range”). Based on performance attribute 306, look and feel attribute 308, quality attribute 310, and price attribute 312, product attribute-based user rating standardization process 300 generates an attribute-based leniency and strictness rating score corresponding to user Jane for product 304 using a trained artificial neural network. Product attribute-based user rating standardization process 300 utilizes the attribute-based leniency and strictness rating score to transform the user rating of 4 to standardized user rating 314. Standardized user rating 314 may be, for example, a 3 out of 5 instead of the 4 given by user Jane.

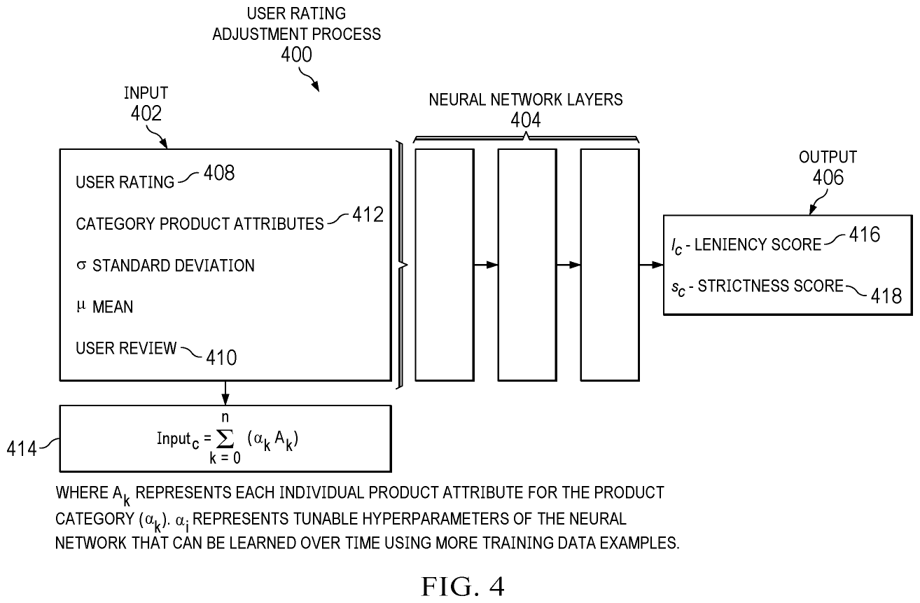

With reference now to FIG. 4, a diagram illustrating an example of a user rating adjustment process is depicted in accordance with an illustrative embodiment. User rating adjustment process 400 may be implemented in a computer, such as, for example, computer 101 in FIG. 1 or computer 202 in FIG. 2.

In this example, user rating adjustment process 400 includes input 402, neural network layers 404, and output 406. Input 402, neural network layers 404, and output 406 represent different layers of a trained neural network. For example, input 402 represents an input layer that provides the data for processing, neural network layers 404 represent a set of hidden layers that perform the processing of the data, and output 406 represents an output layer that provides a result of the data processing.

In this example, input 402 includes user rating 408, user review 410, and category and product attributes 412. User rating 408 and user review 410 may be, for example, user rating and review 302 for product 304 in FIG. 3. Category and product attributes 412 may be, for example, performance attribute 306, look and feel attribute 308, quality attribute 310, and price attribute 312 corresponding to product 304 in FIG. 3. Category and product attributes 412 can also include standard deviation and mean. Neural network layers 404 can utilize, for example, equation 414 to process input 402 to generate output 406. Output 406 includes leniency score 416 and strictness score 418 corresponding to a user for the product.

User rating adjustment process 400 utilizes standardized user ratings (i.e., a user rating adjusted by leniency score 416 and strictness score 418 of the user) to learn the category (αₖ) of the product since these standardized user ratings indicate how important each product attribute corresponding to the product category is to the user. After illustrative embodiments train the neural network, user rating adjustment process 400 utilizes the trained neural network to infer each individual user's leniency and strictness rating score for each respective product category and attribute using equation 414:

$${Input}_{C} = {\sum }_{k = 0}^{n} ( {α}_{k} {A}_{k} )$$

where Aₖ represents each individual product attribute for a product category (αₖ) and αᵢ represents tunable hyperparameters of the neural network that illustrative embodiments learn over time using more training data examples.

Within equation 414, the concept of updating a historical user review can include relative scoring. Also, illustrative embodiments can determine weightings of different product attributes based on the current leniency and strictness rating score of a comparable product. As an exemplary use case scenario, user Jane has bought and is currently reviewing a new product. Jane had also previously bought a brand of similar product (e.g., relative in use and product category), which Jane had also previously reviewed within the same product category. Jane's current review of the new product she just bought may change her previous review of the similar product. For example, Jane just bought a new brand of milk (Acme Farm) and explains in her current review of the product how the new brand of milk is much better than her previous 5-star review of the similar product (Superior Dairy Milk). Based on the current review of the new product, illustrative embodiments can utilize a past review relative scoring adjustment to the previous review (e.g., decrease the user rating down to a 3 or 4 from the previous 5) and connect the 2 reviews together. It should be noted that illustrative embodiments can connect any number of related products that a user references, mentions, or lists in a review of a product.

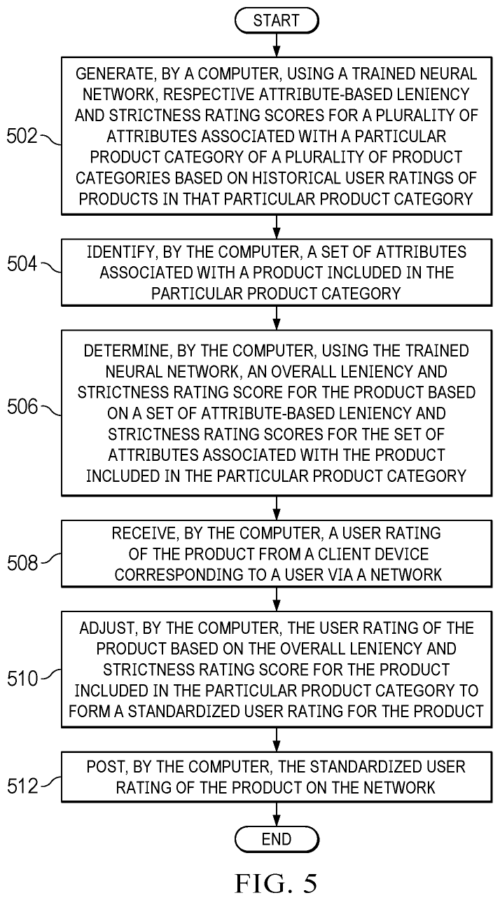

With reference now to FIG. 5, a flowchart illustrating a process for using a trained neural network to transform user ratings of products into standardized user ratings is shown in accordance with an illustrative embodiment. The process shown in FIG. 5 may be implemented in a computer, such as, for example, computer 101 in FIG. 1. For example, the process shown in FIG. 5 may be implemented in user product rating standardizing code 200 in FIG. 1.

The process begins when the computer, using a trained neural network, generates respective attribute-based leniency and strictness rating scores for a plurality of attributes associated with a particular product category of a plurality of product categories based on historical user ratings of products in that particular product category (step 502). In addition, the computer identifies a set of attributes associated with a product included in the particular product category (step 504). Further, the computer, using the trained neural network, determines an overall leniency and strictness rating score for the product based on a set of attribute-based leniency and strictness rating scores for the set of attributes associated with the product included in the particular product category (step 506).

Subsequently, the computer receives a user rating of the product from a client device corresponding to a user via a network (step 508). The computer adjusts the user rating of the product based on the overall leniency and strictness rating score for the product included in the particular product category to form a standardized user rating for the product (step 510). The computer posts the standardized user rating of the product on the network (step 512). Thereafter, the process terminates.

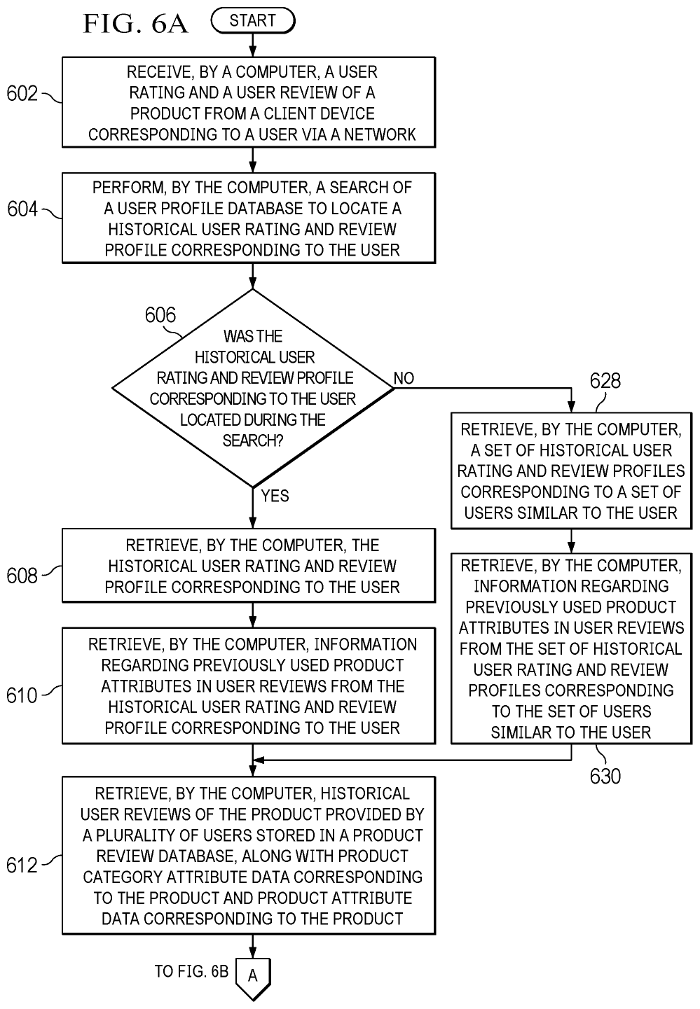

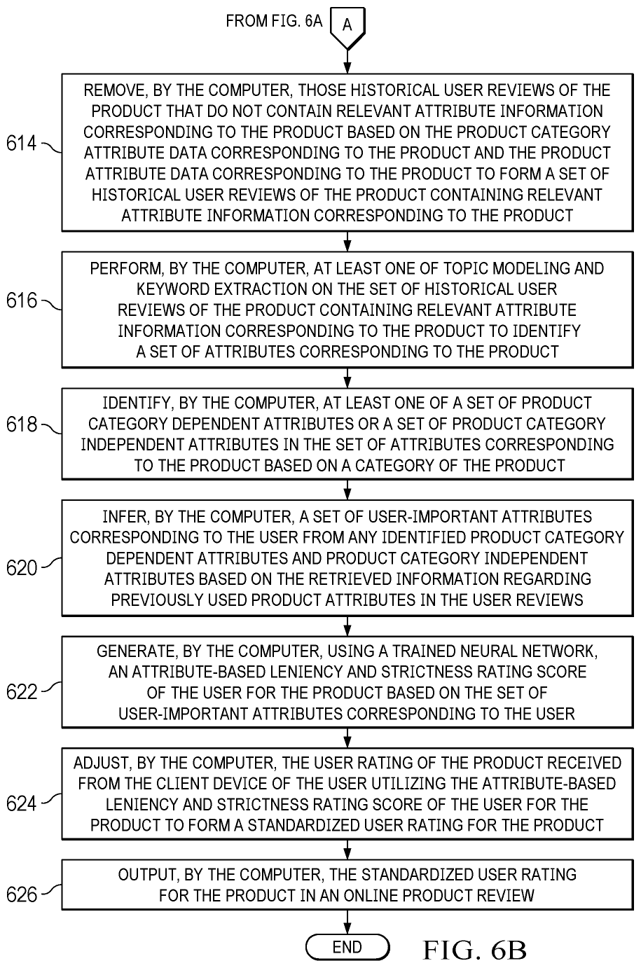

With reference now to FIGS. 6A-6B, a flowchart illustrating a process for adjusting user ratings of products is shown in accordance with an illustrative embodiment. The process shown in FIGS. 6A-6B may be implemented in a computer, such as, for example, computer 101 in FIG. 1. For example, the process shown in FIGS. 6A-6B may be implemented in user product rating standardizing code 200 in FIG. 1.

The process begins when the computer receives a user rating and a user review of a product from a client device corresponding to a user via a network (step 602). In response to receiving the user rating and the user review of the product, the computer performs a search of a user profile database to locate a historical user rating and review profile corresponding to the user (step 604).

Afterward, the computer makes a determination as to whether the historical user rating and review profile corresponding to the user was located in the user profile database during the search (step 606). If the computer determines that the historical user rating and review profile corresponding to the user was located in the user profile database during the search, yes output of step 606, then the computer retrieves the historical user rating and review profile corresponding to the user from the user profile database (step 608). In addition, the computer retrieves information regarding previously used product attributes in user reviews from the historical user rating and review profile corresponding to the user to form retrieved information regarding previously used product attributes in user reviews (step 610).

The computer also retrieves historical user reviews of the product provided by a plurality of users stored in a product review database, along with product category attribute data corresponding to the product and product attribute data corresponding to the product (step 612). Further, the computer removes those historical user reviews of the product that do not contain relevant attribute information corresponding to the product based on the product category attribute data corresponding to the product and the product attribute data corresponding to the product to form a set of historical user reviews of the product containing relevant attribute information corresponding to the product (step 614). Furthermore, the computer performs at least one of topic modeling and keyword extraction on the set of historical user reviews of the product containing relevant attribute information corresponding to the product to identify a set of attributes corresponding to the product (step 616).

The computer then identifies at least one of a set of product category dependent attributes or a set of product category independent attributes in the set of attributes corresponding to the product based on a category of the product (step 618). Moreover, the computer infers a set of user-important attributes corresponding to the user from any identified product category dependent attributes and product category independent attributes based on the retrieved information regarding previously used product attributes in the user reviews (step 620). The computer, using a trained neural network, generates an attribute-based leniency and strictness rating score of the user for the product based on the set of user-important attributes corresponding to the user (step 622).

The computer adjusts the user rating of the product received from the client device of the user utilizing the attribute-based leniency and strictness rating score of the user for the product to form a standardized user rating for the product (step 624). The computer outputs the standardized user rating for the product in an online product review (step 626). Thereafter, the process terminates.

Returning again to step 606, if the computer determines that the historical user rating and review profile corresponding to the user was not located in the user profile database during the search, no output of step 606, then the computer retrieves a set of historical user rating and review profiles corresponding to a set of users similar to the user (step 628). In addition, the computer retrieves information regarding previously used product attributes in user reviews from the set of historical user rating and review profiles corresponding to the set of users similar to the user to form retrieved information regarding previously used product attributes in user reviews (step 630). Thereafter, the process returns to step 612.

Thus, illustrative embodiments of the present invention provide a computer-implemented method, computer system, and computer program product for using a trained neural network to standardize user product ratings in online systems. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for using a trained neural network to transform user ratings into standardized user ratings, the computer-implemented method comprising:
generating, by a computer, using the trained neural network, respective attribute-based leniency and strictness rating scores for a plurality of attributes associated with a particular product category of a plurality of product categories based on historical user ratings of products in the particular product category;
identifying, by the computer, a set of attributes associated with a product included in the particular product category;
determining, by the computer, using the trained neural network, an overall leniency and strictness rating score for the product based on a set of attribute-based leniency and strictness rating scores for the set of attributes associated with the product included in the particular product category;
receiving, by the computer, a user rating of the product from a client device corresponding to a user via a network; and
adjusting, by the computer, the user rating of the product based on the overall leniency and strictness rating score for the product included in the particular product category to form a standardized user rating for the product.

2. The computer-implemented method of claim 1 further comprising:
receiving, by the computer, the user rating and a user review of the product from the client device corresponding to the user via the network;
performing, by the computer, a search of a user profile database to locate a historical user rating and review profile corresponding to the user in response to receiving the user rating and the user review of the product; and
determining, by the computer, whether the historical user rating and review profile corresponding to the user was located in the user profile database during the search.

3. The computer-implemented method of claim 2 further comprising:
responsive to the computer determining that the historical user rating and review profile corresponding to the user was not located in the user profile database during the search, retrieving, by the computer, a set of historical user rating and review profiles corresponding to a set of users similar to the user; and
retrieving, by the computer, information regarding previously used product attributes in user reviews from the set of historical user rating and review profiles corresponding to the set of users similar to the user to form retrieved information regarding previously used product attributes in user reviews.

4. The computer-implemented method of claim 2 further comprising:
responsive to the computer determining that the historical user rating and review profile corresponding to the user was located in the user profile database during the search, retrieving, by the computer, the historical user rating and review profile corresponding to the user from the user profile database; and
retrieving, by the computer, information regarding previously used product attributes in user reviews from the historical user rating and review profile corresponding to the user to form retrieved information regarding previously used product attributes in user reviews.

5. The computer-implemented method of claim 4 further comprising:
retrieving, by the computer, historical user reviews of the product provided by a plurality of users stored in a product review database, along with product category attribute data corresponding to the product and product attribute data corresponding to the product; and
removing, by the computer, those historical user reviews of the product that do not contain relevant attribute information corresponding to the product based on the product category attribute data corresponding to the product and the product attribute data corresponding to the product to form a set of historical user reviews of the product containing relevant attribute information corresponding to the product.

6. The computer-implemented method of claim 5 further comprising:
performing, by the computer, at least one of topic modeling and keyword extraction on the set of historical user reviews of the product containing relevant attribute information corresponding to the product to identify a set of attributes corresponding to the product; and
identifying, by the computer, at least one of a set of product category dependent attributes or a set of product category independent attributes in the set of attributes corresponding to the product based on a category of the product.

7. The computer-implemented method of claim 6 further comprising:
inferring, by the computer, a set of user-important attributes corresponding to the user from any identified product category dependent attributes and product category independent attributes based on the retrieved information regarding previously used product attributes in user reviews.

8. The computer-implemented method of claim 7 further comprising:
generating, by the computer, using the trained neural network, an attribute-based leniency and strictness rating score of the user for the product based on the set of user-important attributes corresponding to the user.

9. The computer-implemented method of claim 8 further comprising:
adjusting, by the computer, the user rating of the product received from the client device of the user utilizing the attribute-based leniency and strictness rating score of the user for the product to form a standardized user rating for the product.

10. The computer-implemented method of claim 9 further comprising:
outputting, by the computer, the standardized user rating for the product in an online product review.

11. A computer system for using a trained neural network to transform user ratings into standardized user ratings, the computer system comprising:
a communication fabric;
a storage device connected to the communication fabric, wherein the storage device stores program instructions; and
a processor connected to the communication fabric, wherein the processor executes the program instructions to:
generate, using the trained neural network, respective attribute-based leniency and strictness rating scores for a plurality of attributes associated with a particular product category of a plurality of product categories based on historical user ratings of products in the particular product category;
identify a set of attributes associated with a product included in the particular product category;
determine, using the trained neural network, an overall leniency and strictness rating score for the product based on a set of attribute-based leniency and strictness rating scores for the set of attributes associated with the product included in the particular product category;
receive a user rating of the product from a client device corresponding to a user via a network; and
adjust the user rating of the product based on the overall leniency and strictness rating score for the product included in the particular product category to form a standardized user rating for the product.

12. The computer system of claim 11, wherein the processor further executes the program instructions to:
receive the user rating and a user review of the product from the client device corresponding to the user via the network;
perform a search of a user profile database to locate a historical user rating and review profile corresponding to the user in response to receiving the user rating and the user review of the product; and
determine whether the historical user rating and review profile corresponding to the user was located in the user profile database during the search.

13. The computer system of claim 12, wherein the processor further executes the program instructions to:
retrieve a set of historical user rating and review profiles corresponding to a set of users similar to the user in response to determining that the historical user rating and review profile corresponding to the user was not located in the user profile database during the search; and
retrieve information regarding previously used product attributes in user reviews from the set of historical user rating and review profiles corresponding to the set of users similar to the user to form retrieved information regarding previously used product attributes in user reviews.

14. The computer system of claim 12, wherein the processor further executes the program instructions to:
retrieve the historical user rating and review profile corresponding to the user from the user profile database in response to determining that the historical user rating and review profile corresponding to the user was located in the user profile database during the search; and
retrieve information regarding previously used product attributes in user reviews from the historical user rating and review profile corresponding to the user to form retrieved information regarding previously used product attributes in user reviews.

15. The computer system of claim 14, wherein the processor further executes the program instructions to:
retrieve historical user reviews of the product provided by a plurality of users stored in a product review database, along with product category attribute data corresponding to the product and product attribute data corresponding to the product; and
remove those historical user reviews of the product that do not contain relevant attribute information corresponding to the product based on the product category attribute data corresponding to the product and the product attribute data corresponding to the product to form a set of historical user reviews of the product containing relevant attribute information corresponding to the product.

16. A computer program product for using a trained neural network to transform user ratings into standardized user ratings, the computer program product comprising a computer-readable storage medium having program instructions embodied therewith, the program instructions executable by a computer to cause the computer to perform a method of:
generating, by the computer, using the trained neural network, respective attribute-based leniency and strictness rating scores for a plurality of attributes associated with a particular product category of a plurality of product categories based on historical user ratings of products in the particular product category;
identifying, by the computer, a set of attributes associated with a product included in the particular product category;
determining, by the computer, using the trained neural network, an overall leniency and strictness rating score for the product based on a set of attribute-based leniency and strictness rating scores for the set of attributes associated with the product included in the particular product category;
receiving, by the computer, a user rating of the product from a client device corresponding to a user via a network; and
adjusting, by the computer, the user rating of the product based on the overall leniency and strictness rating score for the product included in the particular product category to form a standardized user rating for the product.

17. The computer program product of claim 16 further comprising:
receiving, by the computer, the user rating and a user review of the product from the client device corresponding to the user via the network;
performing, by the computer, a search of a user profile database to locate a historical user rating and review profile corresponding to the user in response to receiving the user rating and the user review of the product; and
determining, by the computer, whether the historical user rating and review profile corresponding to the user was located in the user profile database during the search.

18. The computer program product of claim 17 further comprising:
responsive to the computer determining that the historical user rating and review profile corresponding to the user was not located in the user profile database during the search, retrieving, by the computer, a set of historical user rating and review profiles corresponding to a set of users similar to the user; and
retrieving, by the computer, information regarding previously used product attributes in user reviews from the set of historical user rating and review profiles corresponding to the set of users similar to the user to form retrieved information regarding previously used product attributes in user reviews.

19. The computer program product of claim 17 further comprising:
responsive to the computer determining that the historical user rating and review profile corresponding to the user was located in the user profile database during the search, retrieving, by the computer, the historical user rating and review profile corresponding to the user from the user profile database; and
retrieving, by the computer, information regarding previously used product attributes in user reviews from the historical user rating and review profile corresponding to the user to form retrieved information regarding previously used product attributes in user reviews.

20. The computer program product of claim 19 further comprising:
retrieving, by the computer, historical user reviews of the product provided by a plurality of users stored in a product review database, along with product category attribute data corresponding to the product and product attribute data corresponding to the product; and
removing, by the computer, those historical user reviews of the product that do not contain relevant attribute information corresponding to the product based on the product category attribute data corresponding to the product and the product attribute data corresponding to the product to form a set of historical user reviews of the product containing relevant attribute information corresponding to the product.
